(19) United States
(12) Patent Application Publication
(10) Pub. No.: US 2012/0026585 A1
(43) Pub. Date: Feb. 2, 2012

(54) SHUTTER UNIT AND THREE DIMENSIONAL IMAGE DISPLAY DEVICE HAVING THE SAME

(75) Inventors: Hui Nam, Yongin-city (KR); Beom-Shik Kim, Yongin-city (KR)

(73) Assignee: Samsung Mobile Display Co. Ltd., Yongin-city (KR)

(21) Appl. No.: 13/007,396

(22) Filed: Jan. 14, 2011

(30) Foreign Application Priority Data
Jul. 30, 2010 (KR) 10-2010-0074210

(51) Int. Cl. G02B 27/26

(52) U.S. Cl. 359/465

(57) ABSTRACT

A three dimensional image display device is disclosed. In one embodiment, the device includes: i) a display panel that configured to selectively display one of a left-eye image and a right-eye image, ii) a first polarizing plate positioned on the display panel, and iii) a first retarder positioned on the first polarizing plate. The device also includes a shutter unit opposite to the display unit and including i) shutter spectacles configured to selectively transmit one of the left-eye image and the right-eye image, ii) a second polarizing plate positioned on the shutter spectacles between the shutter spectacles and the display unit, and iii) a second retarder positioned on the second polarizing plate and opposite to the first retarder.

### RELATED APPLICATIONS

This application claims priority to and the benefit of Korean Patent Application No. 10-2010-0074210 filed in the Korean Intellectual Property Office on Jul. 30, 2010, the entire contents of which are incorporated herein by reference.

### BACKGROUND

1. Field

The described technology generally relates to a three dimensional image display device, and more particularly, to a shutter unit including a shutter spectacles and a three dimensional image display device having the same.

2. Description of the Related Technology

A three dimensional (3D) image display device generally performs digital sampling and a series of signal processing on image signals transmitted from a video card to display the images.

In the 3D display device, a video signal scanning method is largely classified into a progressive scanning method or an interlaced scanning method, etc. In the progressive scanning method, an image of one frame is formed of one sheet of field image, while in interlaced scan method, an image of one frame is generally formed of two sheet of field images.

In addition, a 3D image technology generally uses binocular parallax to provide a sense of a stereoscopic effect of an object, wherein the binocular parallax is generally a major factor in recognizing a stereoscopic effect in a short range. A method of watching the 3D image is largely classified into a method of wearing spectacles (e.g., 3D viewing glasses) and an autostereoscopy method that does not wear spectacles. Among those, as the method of wearing spectacles, there are an anaglyph method of wearing color spectacles of blue and red on both eyes, a polarization method of wearing polarizing spectacles having different polarization directions, and a shutter unit method (or time-division method) of wearing spectacles mounted with including a liquid crystal shutter that periodically repeats a time divided screen and that is synchronized with the period.

Among others, the shutter unit method implements the 3D image by allowing a display unit of an organic light emitting diode (OLED) display or a liquid crystal display (LCD) to alternately rapidly displaying a left-eye image and a right-eye image and by synchronizing a shutter unit with a display unit to open and close portions corresponding to a left eye or a right eye for a predetermined time. For example, according to the shutter unit method, the operation of opening the left-eye shutter of the shutter unit when the display unit displays the left-eye image and opening the right-eye shutter of the shutter unit when the display unit displays the right-eye image is very rapidly alternately repeated.

Meanwhile, a polarizing plate is typically attached on the surface of the display unit of the 3D display device In order to receive light emitted from the display unit to the outside through the polarizing plate and forming an image, the polarizing plate is also attached to the surface of the shutter unit. In particular, when the display unit is the liquid crystal display (LCD), the polarizing plate having a linear optical axis is attached to the surface of the display unit in order to implement black and when the display unit is the organic light emitting diode display, the polarizing plate having the linear optical axis is attached to the surface of the display unit in order to minimize the external light reflection. As such, the polarizing plate having the linear optical axis is attached to the display unit and thus, the polarizing plate having the same linear optical axis as the polarizing plate attached to the display unit is also attached to the surface of the shutter unit.

However, the above 3D device has a problem in causing the difference between the optical axis of light emitted from the display unit and the optical axis of the polarizing plate attached to the surface of the shutter since the light emitted from the display unit through the polarizing plate having the linear optical axis has the linear optical axis when the shutter unit is tilted based on the display unit.

That is, luminance degrades due to the difference between the polarization direction of the incident light and the polarization direction of the polarizing plate attached to the surface of the shutter unit when the light emitted from the display unit is incident on the shutter unit, in the case where the shutter unit is tilted based on the display unit without being not positioned at the front of the display unit.

The above information disclosed in this Background section is only for enhancement of understanding of the background of the described technology and therefore it may contain information that does not form the prior art that is already known in this country to a person of ordinary skill in the art.

### SUMMARY

One inventive aspect is a shutter unit having advantage of minimizing deterioration in luminance and a three dimensional image display device having the same.

Another aspect is a three dimensional image display device, including: a display unit including a display panel that selectively displays one of a left-eye image and a right-eye image, a first polarizing plate positioned on the display panel, and a first retarder positioned on the first polarizing plate; and a shutter unit opposite to the display unit and including shutter spectacles selectively transmitting one of the left-eye image and the right-eye image, a second polarizing plate positioned on the shutter spectacles between the shutter spectacles and the display unit, and a second retarder positioned on the second polarizing plate and opposite to the first retarder.

The first retarder and the second retarder may be a ¼ wavelength plate.

The optical axes of the first polarizing plate and the second polarizing plate may be the same.

The display panel may include a liquid crystal.

The display panel may include an organic light emitting diode.

The display unit may further include a third retarder positioned between the display panel and the first polarizing plate.

The shutter spectacles may include a first substrate, a second substrate facing the first substrate, and a liquid crystal layer positioned between the first substrate and the second substrate.

Another aspect is a shutter unit used for a display unit selectively displaying one of a left-eye image and a right-eye image, including: shutter spectacles opposite to the display unit and selectively transmitting only one of the left-eye image and the right-eye image; a polarizing plate positioned on the shutter spectacles between the shutter spectacles and the display unit; and a retarder positioned on the polarizing plate and opposite to the display unit.

### BRIEF DESCRIPTION OF THE DRAWINGS

FIG. 1 is a diagram showing a three dimensional image display device according to a first embodiment.

FIG. 2 is a block diagram showing the three dimensional image display device according to the first embodiment.

FIG. 3 is a cross-sectional view showing the three dimensional image display device according to the first embodiment.

FIG. 4 is a diagram showing a path through which light emitted from a display unit of the three dimensional image display device according to the first embodiment is incident on a shutter unit.

FIG. 5 is a diagram for explaining an effect of the three dimensional image display device according to the first embodiment.

FIG. 6 is a diagram showing a three dimensional image display device according to a second embodiment.

### DETAILED DESCRIPTION

Embodiments will be described more fully hereinafter with reference to the accompanying drawings. As those skilled in the art would realize, the described embodiments may be modified in various different ways.

The drawings and description are to be regarded as illustrative in nature and not restrictive. Like reference numerals designate like elements throughout the specification.

In addition, in describing a second embodiment, components different from the first embodiment will be mainly described.

In addition, the size and thickness of each component shown in the drawings are arbitrarily shown for understanding and ease of description, but are not considered limiting.

In the drawings, the thickness of layers, films, panels, regions, etc., may be exaggerated for clarity. In the drawings, the thickness of layers, films, panels, regions, etc., may be exaggerated for clarity. It will be understood that when an element such as a layer, film, region, or substrate is referred to as being “on” another element, it can be directly on the other element or intervening elements may also be present.

In addition, unless explicitly described to the contrary, the word “comprise” and variations such as “comprises” or “comprising”, will be understood to imply the inclusion of stated elements but not the exclusion of any other elements. In addition, “˜on” is neither positioned on or below a portion of a target nor positioned on the upper side based on a gravity direction, throughout the specification.

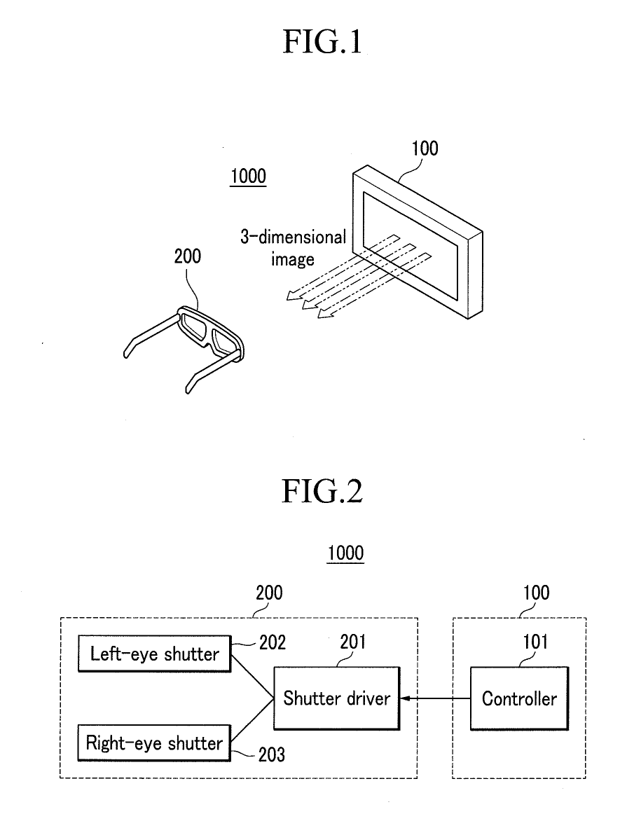

Hereinafter, a 3D image display device according to a first embodiment will be described with reference to FIGS. 1 to 5.

FIG. 1 is a diagram showing a 3D image display device according to the first embodiment.

As shown in FIG. 1, a 3D image display device 1000 includes a display unit 100 and a shutter unit 200.

The display unit 100 may be a liquid crystal display (LCD) and displays a 3D image in an interlaced scanning method. In this case, the interlaced scan method implies a method that divides a 3D image of one frame into a left-eye image and a right-eye image and time-divides a left-eye image and a right-eye image to periodically repeat them.

The shutter unit 200 has a type of spectacles and is synchronized with the display unit 100 to open and closes portions (a left spectacle lens or a right spectacle lens) corresponding a left eye or a right eye for a predetermined time when the display unit 100 displays the 3D image by time-dividing a left-eye image and a right-eye image. For example, the shutter unit 200 opens a left-eye shutter when the display unit 100 displays a left-eye image and opens a right-eye shutter when the display unit 100 displays a right-eye image. The shutter unit 200 very rapidly alternately repeats the operation.

FIG. 2 is a block diagram showing the 3D image display device according to the first embodiment. FIG. 2 is a block diagram showing a configuration of the display unit 100 and the shutter unit 200.

As shown in FIG. 2, the display unit 100 includes a controller 101 and the shutter unit 200 includes a shutter driver 201, a left-eye shutter 202, and a right-eye shutter 203.

The controller 101 transmits synchronization signals such as a vertical synchronization signal or a horizontal synchronization signal of a 3D image displayed in the display unit 100 to the shutter driver 201 of the shutter unit 200. In this case, the synchronization signal may be transmitted and received in wire or wireless.

In the 3D image display device 1000 according to the first embodiment, the controller 101 may be included in the display unit 100 or in the 3D image display device according to another embodiment, the controller may be positioned at the outside of the display unit 100.

The shutter driver 201 receives the synchronization signal of the 3D image from the controller 101 and supplies driving signals to the left-eye shutter 202 and right-eye shutter 203 of the shutter unit 200 to be synchronized with a boundary between the left-eye image and the right-eye image of the 3D image according to the synchronization signal.

The left-eye shutter 202 and the right-eye shutter 203 of the shutter unit 200 may be opened or closed by the driving signal supplied from the shutter driver 201 and in particular, may be sequentially opened or closes to be synchronized with the boundary between the left-eye image and the right-eye image of the 3D image according to the synchronization signal of the shutter driver 201.

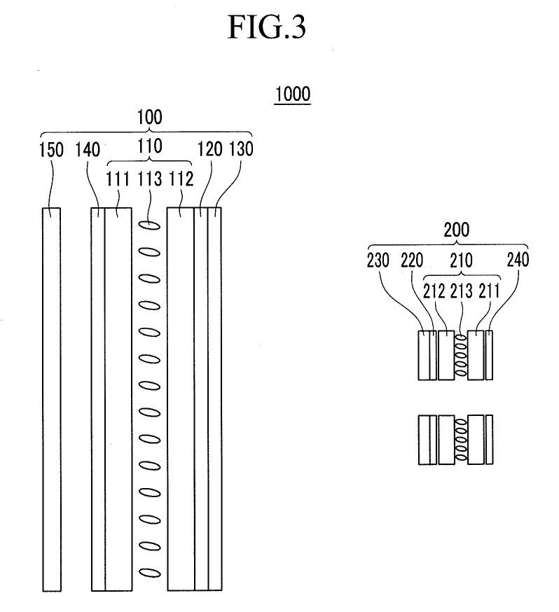

Hereinafter, components configuring the display unit 100 and the shutter unit 200, respectively, will be described in detail with reference to FIG. 3.

FIG. 3 is a cross-sectional view showing the 3D image display device according to a first embodiment.

As shown in FIG. 3, a display unit 100 includes a display panel 110, a first polarizing plate 120, a first retarder 130, a first rear polarizing plate 140 and a light source 150.

The display panel 110 selectively displays one of the left-eye image and the right-eye image and includes a first display substrate 111, a second display substrate 112, and a first liquid crystal layer 113 positioned between the first display substrate 111 and the second display substrate 112.

At least one of the first and second display substrates 111 and 112 may include a substrate made of glass, plastic, or metal, ore the like, a metal pattern formed on the substrate to be used as an electrode, and a color filter, or the like. Longitudinal or transverse electric field is formed in a space between the first display substrate 111 and the second display substrate 112 and the liquid crystal included in the first liquid crystal layer 113 serves as a shutter according to the longitudinal or the transverse electric field.

The first polarizing plate 120 is positioned between the display panel 110 and the first retarder 130 and has a linear optical axis extending in a first direction. The first polarizing plate 120 serves to pass only light having the linear optical axis extending in the first direction and the light passing through the first polarizing plate 120 has the linear optical axis extending in the first direction. That is, the light emitted to the outside through the display panel 110 is linearly polarized while passing through the first polarizing plate 120.

The first retarder 130 is disposed on the first polarizing plate 120 and is a ¼ wavelength plate. The optical axis of the first retarder 130 is tilted by about 45° with respect to the optical axis of the first polarizing plate 120 and the light linearly polarized by passing through the first polarizing plate 120 is circularly polarized by passing through the first retarder 130. That is, the light sequentially passing through the display panel 110, the first polarizing plate 120, and the first retarder 130 is circularly polarized and the 3D image displayed in the display unit 100 is implemented by the circularly polarized light.

The first rear polarizing plate 140 faces the first polarizing plate 120, interposing the display panel 110 therebetween and has a linear optical axis extending in the second direction orthogonal to the first direction. The first rear polarizing plate 140 serves to pass only the light having the linear optical axis extending in the second direction and the light passing through the first rear polarizing plate 140 has the linear optical axis extending in the second direction. That is, light emitted from the light source 150 and input to the display panel 110 through the first rear polarizing plate 140 has the linear optical axis extending in the second direction substantially orthogonal to the first direction, while passing through the first rear polarizing plate 140 and when the first liquid crystal layer 113 of the display panel 110 is completely opened, that is, electric field is not generated in the display panel 110, the light from the light source 150 is absorbed in the first polarizing plate 120 such that the display panel 110 displays black.

As such, the light emitted from the display unit 100 is circularly polarized, thereby implementing the 3D image.

The shutter unit 200 may be used as the spectacle form when watching the 3D image implemented from the display unit 100 by using the shutter unit 200 and includes a shutter spectacles 210, a second polarizing plate 220, a second retarder 230, and a second rear polarizing plate 240.

The shutter spectacles 210 face the display unit 100 and selectively transmit only one image of the left-eye image and the right-eye image displayed by the display unit 100 to the left eye or the right eye of the user and includes a first spectacles substrate 211, a second spectacles substrate 212, and a second liquid crystal layer 213 positioned between the first spectacles substrate 211 and the second spectacles substrate 212.

At least one of the first and second spectacles substrates 211 and 212 includes a substrate made of glass or plastic, etc., and a metal pattern formed on the substrate to be used as an electrode and the like. A longitudinal or transverse electric field is formed in a space between the first spectacles substrate 211 and the second spectacles substrate 212 and the liquid crystal included in the second liquid crystal layer 213 serves as the shutter along the longitudinal or transverse electric field.

The second polarizing plate 220 is disposed on the shutter spectacles 210 and in particular, disposed between shutter spectacles 210 and a second retarder 230. The second polarizing plate 220 has the linear optical axis extending in the first direction, similar to the first polarizing plate 120. The second polarizing plate 220 serves to pass only the light having the linear optical axis extending in the first direction and the light passing through the second polarizing plate 220 has the linear optical axis extending in the first direction. That is, the light emitted to the outside through the display panel 110 is linearly polarized, while passing through the second polarizing plate 220.

The second retarder 230 is disposed on the second polarizing plate 220 and faces the first retarder 130. The second retarder 230 is a ¼ wavelength plate, similar to the first retarder 130. The optical axis of the second retarder 230 is tilted by about 45° with respect to the optical axis of the second polarizing plate 220 and the light emitted and circularly polarized from the display unit 100 is linearly polarized, passing through the second retarder 230. That is, the light circularly polarized and emitted sequentially passing through the display panel 110, the first polarizing plate 120, and the first retarder 130 is again linearly polarized while passing through the second retarder 230, wherein the linearly polarized light is incident on the shutter spectacles 210 through the second polarizing plate 220.

As described above, the circularly polarized light forming the 3D image implemented by the display unit 100 is linearly polarized passing through the second retarder 230 and the linearly polarized light is incident on the shutter spectacles 210 through the second polarizing plate 220. Thereby, the circularly light emitted from the first display unit 100 and forming the 3D image is incident on the shutter spectacles 210 without deteriorating the luminance.

The second rear polarizing plate 240 faces the second polarizing plate 220, interposing the shutter spectacles 210 therebetween and has the linear optical axis extending in the second direction orthogonal to the first direction. The second rear polarizing plate 240 serves to pass only the light having the linear optical axis extending in the second direction and the light passing through the second rear polarizing plate 240 has the linear optical axis extending in the second direction. That is, the light emitted from the display unit 100 and input to the shutter spectacles 210 through the second retarder 230 and the second polarizing plate 220 has the linear optical axis extending in the first direction and when the second liquid crystal layer 213 of the shutter spectacles 210 is completely opened, that is, when the electric field is not generated in the shutter spectacles 210, the light from the display unit 100 is absorbed in the second rear polarizing plate 240 to display black.

As such, the circularly polarized light emitted from the display unit 100 is selectively incident on the shutter unit 200 and the user using the shutter unit 200 recognizes the 3D image.

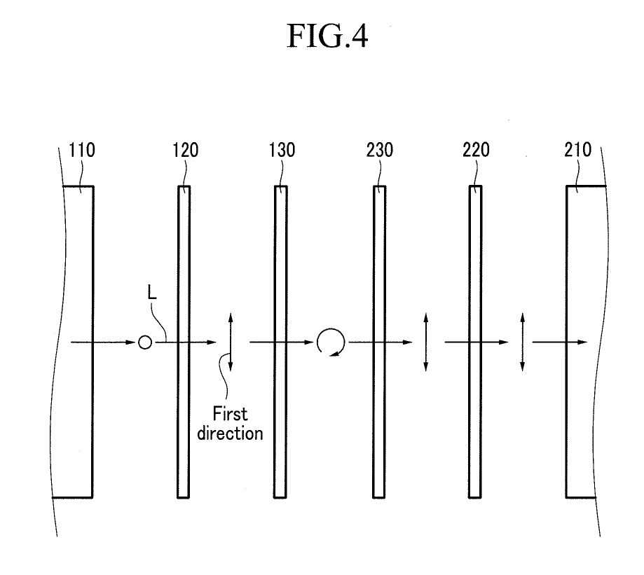

Hereinafter, the path of light from the above-mentioned display panel 110 to the shutter spectacles 210 will be described in detail with reference to FIG. 4.

FIG. 4 is a diagram showing a path through which light emitted from a display unit of the 3D image display device according to the first embodiment is incident on a shutter unit.

As shown in FIG. 4, the light (L) passing through the display panel 110 is linearly polarized in the first direction that is the optical axis direction of the first polarizing plate 120, while passing through the first polarizing plate 120. The linearly polarized light is changed into the circular polarization while passing through the first retarder 130 that is a ¼ wavelength plate to display the 3D image. That is, the display unit 100 emits the circularly polarized light to display the 3D image.

The circularly polarized light is linearly polarized in the first direction, while passing through the second retarder 230 of the shutter unit 200. The linearly polarized light is incident on the shutter spectacles 210 while passing through second polarizing plate 220 having the optical axis of the first direction.

That is, the linearly polarized light passing through the first polarizing plate 120 is again circularly polarized and then linearly polarized again, passing through the first retarder 130 and the second retarder 230 and the linearly polarized light is incident on shutter spectacles 210 through the second polarizing plate 220, thereby not deteriorating the luminance until the linearly polarized light passing through the first polarizing plate 120 of the first display unit 100 passes through the second polarizing plate 220 of the shutter unit 200.

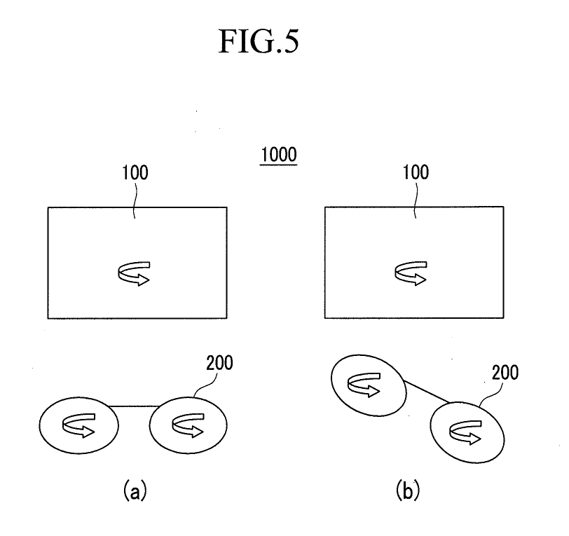

FIG. 5 is a diagram for explaining an effect of the 3D image display device according to the first embodiment.

In addition, even in the state where the shutter unit 200 is face to face with the display unit 100 shown in FIG. 5A and in the state where the shutter unit 200 is tilted with respect the display unit 100 shown in FIG. 5B, the light emitted from the display unit 100 is circularly polarized and the circularly polarized light is incident on the shutter unit 200 in the circularly polarized state, such that the difference between the optical axis of light emitted from the display unit 100 and the optical axis of the second polarizing plate 220 attached to the surface of the shutter unit 200 does not occur. In other words, the light linearly polarized passing through the first polarizing plate 120 of the first display unit 100 is circularly polarized, passing through the first retarder 130 and is input to the shutter unit 200 and the circularly polarized light incident on the shutter unit 200 is again linearly polarized, passing through the second retarder 230 and is input to the shutter spectacles 210 through the second polarizing plate 220, thereby not deteriorating the luminance until the light emitted from the display unit 100 is incident on the shutter unit 200.

As described above, in the 3D image display device 1000 according to the first embodiment, the display unit 100 has the first polarizing plate 120 having the linear optical axis, the shutter unit 200 has the second polarizing plate 220 having the linear optical axis, and the deterioration of the luminance is minimized when the light emitted from the display unit 100 is incident on the shutter unit 200 even though the shutter unit 200 is tilted to the display unit 100.

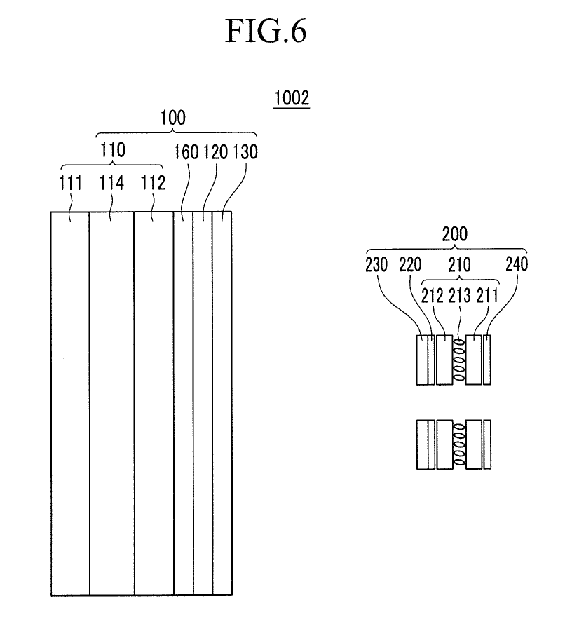

Hereinafter, 3D image display device 1002 according to a second embodiment will be described with reference to FIG. 6.

FIG. 6 is a diagram showing a 3D image display device according to a second embodiment.

As shown in FIG. 6, the display unit 100 includes an organic light emitting diode (OLED) display, includes a display panel 110, a first polarizing plate 120, a first retarder 130, and a third retarder 160.

The display panel 110 includes the first display substrate 111, the second display substrate 112 and the organic light emitting diode 114 positioned between the first display substrate 111 and the second display substrate 112. The organic light emitting diode 114 is a self-light emitting element and light-emits the organic light emitting layer included in the organic light emitting diode 114 to display the 3D image.

The third retarder 160 is positioned between the display panel 110 and the first polarizing plate 120 and is the ¼ wavelength plate. The optical axis of the third retarder 160 is further tilted by 45° with respect to the optical axis of the first polarizing plate 120 and the light linearly polarized passing through the first polarizing plate 120 from the outside is circularly polarized, passing through the third retarder 160. As such, the external light is linearly polarized in the polarization direction of the first polarizing plate 120, passing through the first polarizing plate 120 and the linearly polarized light is again circularly polarized, passing through the third retarder 160 that is a ¼ wavelength plate. As an example, when the circular polarization is the left circular polarization, the left circular polarized light is reflected by the electrodes configuring the organic light emitting diode 114 in the display panel 110, such that the phase of the left circular polarized light is changed by 180° into the right circular polarized light. The light changed into the right circular polarization is linearly polarized again passing through the third retarder 160 and the axial direction of the linearly polarized light is a direction opposite to the optical axis direction of the first polarizing plate 120, which is absorbed in the first polarizing plate 120 as it is.

That is, the third retarder 160 is disposed between the display panel 110 and the first polarizing plate 120 to minimize the external light reflection due to the display panel 110, thereby suppressing the deterioration of the image quality of the 3D image display device 1002.

At least one of the disclosed embodiments minimizes luminance deterioration in displaying 3D images.

The disclosed embodiments are not considered limiting and are intended to cover various modifications and equivalent arrangements included within the spirit and scope of the appended claims.

What is claimed is:

1. A three dimensional image display device, comprising:
a display unit including i) a display panel configured to selectively display one of a left-eye image and a right-eye image, ii) a first polarizing plate positioned on the display panel, and iii) a first retarder positioned on the first polarizing plate; and
a shutter unit opposite to the display unit and including i) shutter spectacles configured to selectively transmit one of the left-eye image and the right-eye image, ii) a second polarizing plate positioned on the shutter spectacles between the shutter spectacles and the display unit, and iii) a second retarder positioned on the second polarizing plate and opposite to the first retarder.

2. The three dimensional image display device of claim 1, wherein each of the first and second retarders comprises a ¼ wavelength plate.

3. The three dimensional image display device of claim 2, wherein the optical axes of the first and second polarizing plates are the same.

4. The three dimensional image display device of claim 1, wherein the display panel includes a liquid crystal layer.

5. The three dimensional image display device of claim 1, wherein the display panel includes an organic light emitting diode.

6. The three dimensional image display device of claim 5, wherein the display unit further includes a third retarder positioned between the display panel and the first polarizing plate.

7. The three dimensional image display device of claim 1, wherein the shutter spectacles include a liquid crystal layer.

8. A shutter unit used for a display unit selectively displaying one of a left-eye image and a right-eye image, comprising:
shutter spectacles opposite to the display unit and configured to selectively transmit only one of the left-eye image and the right-eye image;
a polarizing plate positioned on the shutter spectacles between the shutter spectacles and the display unit; and
a retarder positioned on the polarizing plate and opposite to the display unit.
